(19) United States
(12) Patent Application Publication
(10) Pub. No.: US 2004/0034612 A1
(43) Pub. Date: Feb. 19, 2004

(54) Support vector machines for prediction and classification in supply chain management and other applications

(76) Inventors: Nick Mathewson, Cambridge, MA (US); Roger Dingledine, Somerville, MA (US); Debra Gesimondo, Stow, MA (US)

Correspondence Address: Patent Administrator, Testa, Hurwitz & Thibeault, LLP, High Street Tower, 125 High Street, Boston, MA, 02110, US

(21) Appl. No.: 10/386,125

(22) Filed: Mar. 10, 2003

Related U.S. Application Data
(60) Provisional application No. 60/366,959, filed on Mar. 22, 2002.

(51) Int. Cl. G06F 17/00; G06N 5/02; G06F 15/18; G06F 17/60

(52) U.S. Cl. 706/46; 706/12; 705/1

(57) ABSTRACT

Disclosed are support vector machines for prediction and classification in supply chain management and other applications.

### REFERENCE TO RELATED APPLICATION

The present patent application claims the priority of co-pending U.S. Provisional Patent Application Serial No. 60/366,959 (Attorney Docket: REPU-101) filed Mar. 22, 2002.

### FIELD OF THE INVENTION

The present invention relates generally to the field of supplier relationship management (SRM) and supply chain management (SCM) systems. More particularly, the invention relates to novel implementations of support vector machines (SVMs) capable of operating on non-uniform, “partial” or otherwise limited data to predict transaction outcomes, classify potential transactions, assess transaction risk, and provide degree of confidence values for classifications and predictions. SVMs according to the invention can be implemented in SRM/SCM systems and other systems. While the examples set forth below are directed to supply chain management, those skilled in the relevant area of technology will appreciate that the methods described herein can be applied to a wide range of applications requiring classification and prediction

### BACKGROUND OF THE INVENTION

In many corporations, procurement and supply chain-related costs can represent 60-70% of the enterprise's cost structure. As companies seek to reduce these costs, they have increased outsourcing and global sourcing, resulting in a more complex supplier base and an increased need to manage supply chains and supplier relationships. In response, supply chain management (SCM) and supplier relationship management (SRM) applications have become widely used for analysis, modeling and decision support. Examples of such systems are disclosed in the following U.S. patents, incorporated by reference herein:

U.S. Pat. No. 6,341,266, SAP Aktiengesellschaft (distribution chain management systems);

U.S. Pat. No. 6,332,130, i2 Technologies (supply chain analysis, planning and modeling systems); and

U.S. Pat. No. 5,953,707, Philips Electronics (decision support system for management of supply chain).

The current market for such systems is estimated to be in the range of approximately $10 billion, which is expected to grow to approximately $20 billion in 2004. SRM solutions are particularly important for companies that are multi-geographic, multi-divisional, manage a fragmented supply base, outsource heavily, or have complex supplier interactions involving multiple parties. These may include companies involved in apparel manufacturing, bio-pharmaceuticals, equipment and high-tech manufacturing, global travel services, telecommunications, and consumer goods distribution. In addition, suppliers of existing SCM platforms may wish to incorporate SRM capabilities into their products.

As useful as SCM and SRM systems are in enabling corporations to track, analyze, model and manage supply chains and supplier relationships, they typically share at least one significant deficiency: they cannot provide well-founded predictions about future transactions, or predictions of attributes of current transactions—particularly in the face of incomplete or otherwise limited data.

Many businesses are, by necessity or inadvertence, inconsistent about obtaining all possible data from their transactions. In most cases, it is impossible to obtain data about a transaction without actually conducting it—a prospect that might be prohibitively expensive. For example, a corporation is unlikely to make an expensive purchase simply to answer a question such as: “If I buy 10,000 tons of steel from supplier Y (from whom I've never purchased steel), is it likely to be of the agreed-upon quality?”

In many cases, the arrival of information about a transaction is typically neither instantaneous nor simultaneous. Instead, information about shipping arrives after the order is placed; and quality measurements are made as the product is initially evaluated and then moves through the factory and into the field.

Therefore, it would be useful to provide a system capable of operating on limited available data to generate recommendations and predictions about suppliers and transactions, to answer such questions as: “Given my suppliers of steel, which is most likely to be the best supplier (in terms of any of a number of characteristics including timeliness, quality, price or other) for my next purchase?” or “If I buy N tons of steel from supplier X, what is the probability that X will deliver on time?”

It is also desirable to provide systems that could make predictions about “late-arriving” attributes based on previously-recorded information.

It would also be useful to provide a system that could make extrapolations to answer questions such as: “Given my suppliers of steel and copper, which is most likely to be the best supplier of aluminum (even if I have not previously made aluminum purchases)?”

In short, it would be desirable to provide a system that could render predictions, recommendations or classifications using non-uniform, “partial” or otherwise limited data typical of business and other real-world settings, based on transactions conducted with other suppliers or for other goods or services.

It would also be useful to provide a system capable of identifying “risky” transactions, i.e., transactions having qualities that exceed a certain threshold of risk, thereby to answer questions such as: “Of the 100 proposed transactions scheduled for this week, which are outside my risk tolerance threshold?” or, conversely: “Which 10 are most likely to be successful?”

Finally, it would be desirable to provide such a system that could make predictions or provide classification or recommendation information in any of a wide range of applications, from weather forecasting to stock market analysis.

### SUMMARY OF THE INVENTION

The present invention meets these requirements by providing novel implementations of support vector machines (SVMs) capable of operating on non-uniform, “partial” or otherwise limited data, to predict transaction outcomes, classify potential transactions, assess transaction risk, and provide degree of confidence values for those predictions or classifications. The SVMs of the invention are useful in SRM/SCM systems and many other applications such as weather forecasting and Retail Loss Prevention analysis or prediction.

In one embodiment of the invention, an SVM is configured to learn and predict the performance of suppliers in the supplier base of a company. The SVM can predict transaction outcomes and values of otherwise unknown attributes (e.g., timeliness, price, quality, purity, or freshness) for a prospective transaction. The SVM can also classify transactions or supplier performance as “risky” or “non-risky”, “good” or “bad”, or in accordance with other binary or multi-value classifications.

The SVMs can operate on limited, possibly incomplete samples in first domains (e.g., aluminum or copper purchases) to learn about and predict other domains (e.g., steel purchases). The SVMs can process data with high levels of disparity and limited overlap, as may occur when businesses are inconsistent about collecting or retaining transaction data such as timeliness, price, quality, purity, or other values.

Since the SVMs can use outcomes of past transactions and other data to predict an individual supplier's performance in future transactions, the predictions and other outputs generated by the SVMs can be used for many purposes, including (but not limited to) the following:

1. Assigning a score to each supplier based on its expected performance in a “typical” or prototype transaction.

2. Ranking each supplier within a group based on its expected performance in a “typical” transaction.

3. Predicting the performance of a particular supplier in a specific, planned transaction.

4. Selecting a list of suppliers that are expected to perform best in a specific, planned transaction.

5. Identifying risky transactions by discerning that the transaction differs from ones previously undertaken with a given supplier, or by discerning that transactions similar to the one under consideration have had poor or variable outcomes in the past.

6. Detecting deviations within a supplier's performance by comparing actual to expected performance.

Predictions or classifications based on incomplete data are accomplished by defining an SVM kernel function with a distance measurement that permits unknowns in the data. The distance-based kernel function is tunable through selection of coefficients. A further aspect of the invention includes methods of making predictions based on an incomplete data set, including the steps of selecting a data set having a plurality of unknown data values; manipulating the data set to create a modified data set substantially having a number of data points sufficient to satisfy a selected statistical significance threshold; calculating pair-wise similarity for the modified data set by treating an unknown data value as a function of the pair-wise similarity calculation; and making the prediction in response to the pair-wise similarity.

In another aspect of the invention, when a classification SVM's kernel functions or a regression SVM's basis functions are based on linear point-to-point distance, the SVM can utilize a “fuzzy” plane-to-plane distance method. When the kernel/basis functions are not based on linear distance, a general method described below can be used to adapt them to operate on partial data.

Also described below are augmented implementations of classification and regression SVM techniques, including (1) a method to select appropriate data (for example, in order to select data sets for information about a particular supplier, the SVM can use all of the supplier's data, plus related data from other suppliers); (2) a variation on the SVM algorithm to downplay less-related data; and (3) a processing step applied to the SVM's output that estimates the degree of influence by less-related data on a given decision.

SVMs according to the invention can also be configured to provide degree of confidence values for the predictions and classifications generated by the SVM.

### BRIEF DESCRIPTION OF THE DRAWING FIGURES

Features and advantages of the present invention will become apparent to those skilled in the art from the description below, with reference to the following drawing figures, in which:

FIG. 1 is a flow chart depicting the operation of a prior art classifier SVM.

FIG. 2 illustrates the separation of training data into two classes with representative support vectors, by a classifier SVM.

FIG. 3 depicts the application of a regression SVM.

FIG. 4 is a block diagram of an exemplary prior art system on which the present invention may be implemented.

FIG. 5 is a block diagram showing an example of an SRM system incorporating an SVM in accordance with the present invention.

FIG. 6 is a flowchart illustrating methods steps and results generated by an SVM in accordance with the present invention.

### DESCRIPTION OF ILLUSTRATED EMBODIMENTS

The present invention includes novel implementations of SVMs and systems incorporating such SVMs to enable prediction, classification and other useful results from non-uniform, “partial” or otherwise incomplete data. Although SVMs as a class of trainable learning machines are known to those skilled in the art, SVM theory and operation are next discussed for the convenience of the reader, and to highlight the differences between the present invention and conventional SVMs.

Prior Art SVMs

Examples of Prior Art SVMs: Examples of SVMs are set forth in the following publications incorporated herein by reference:

U.S. Pat. No. 6,327,581, Microsoft Corporation (methods for building SVM classifier, solving quadratic programming problems involved in training SVMs);

U.S. Pat. No. 6,157,921, Barnhill Technologies, LLC (pre-processing of training data for SVMs, including adding dimensionality to each training data point by adding one or more new coordinates to the vector);

U.S. Pat. No. 6,134,344, Lucent Technologies, Inc. (SVMs using reduced set vectors defined by an optimization approach other than the eigenvalue computation used for homogeneous quadratic kernels);

U.S. Pat. No. 6,112,195, Lucent Technologies, Inc. (SVM and preprocessor systems for classification and other applications, in which the preprocessor operates on input data to provide local translation invariance);

WO 01/77855 A1, Telstra New Wave (iterative training process for SVMs, executed on a differentiable form of a primal optimization problem defined on the basis of SVM-defining parameters and the data set);

Christinanini, N. et al., An Introduction to Support Vector Machines and other Kernel-Based Learning Methods, Cambridge University Press, Cambridge 2000; and

Vapnik, V., Statistical Learning Theory, John Wiley and Sons, Inc., 1998.

Principles of Conventional SVMS: In general terms, an SVM is a learning machine having a decision surface parameterized by a set of support vectors and a set of corresponding weighting coefficients. An SVM is characterized by a kernel function, the selection of which determines whether the resulting SVM provides classification, regression or other functions. Through application of the kernel function, the SVM maps input vectors into high dimensional feature space, in which a decision surface (a hyperplane) can be constructed to provide classification or other decision functions. An SVM is also characterized by a “decision rule” that is a function of the corresponding kernel function and support vectors.

An SVM typically operates in two phases: a training phase and a testing phase. During the training phase, a set of support vectors is generated for use in executing the decision rule. During the testing phase, decisions are made using the decision rule. A support vector algorithm is a method for training an SVM. By execution of the algorithm, a training set of parameters is generated, including the support vectors that characterize the SVM.

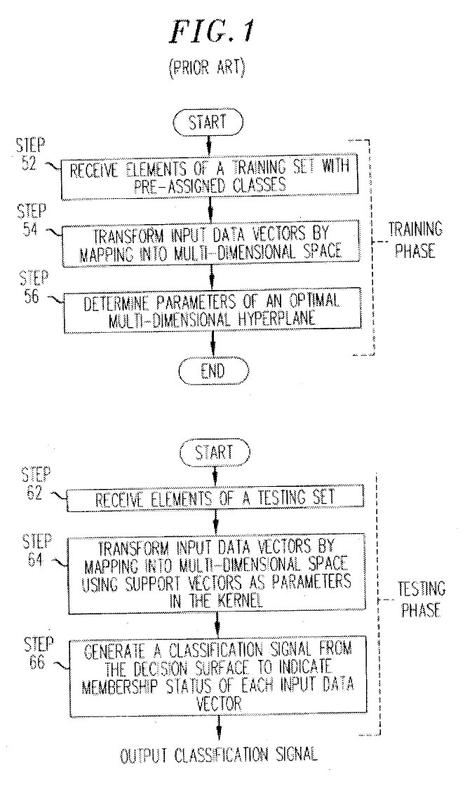

FIG. 1 is a flow chart showing the two-phase operation of a conventional SVM. In the training phase, the SVM receives elements of a training set, and the input data vectors from the training set are transformed into a multi-dimensional space. Then, support vectors and associated weights are determined for an optimal multi-dimensional hyperplane.

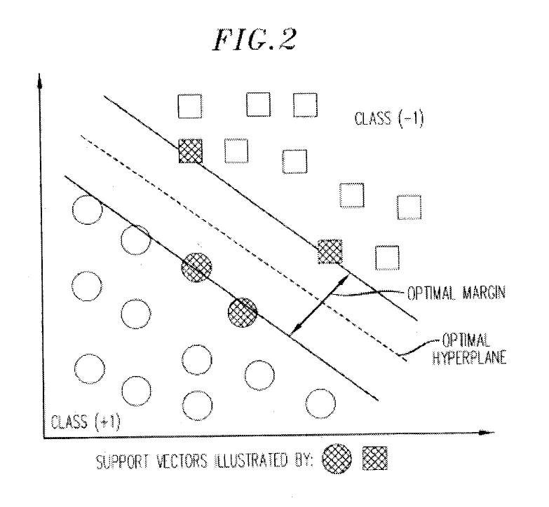

FIG. 2 shows an example in which training data elements are separated into two classes, one class represented by circles and the other by boxes. This is typical of a 2-class pattern recognition problem, such as an SVM trained to separate patterns of “human face images” from patterns that are not human face images. An optimal hyperplane is the linear decision function with maximal margin between the vectors of two classes; i.e., the decision surface separating the training data with maximal margin. As shown in FIG. 2, to construct an optimal hyperplane, the SVM need only take into account the small subset of trained data elements that determine this maximal margin. This subset of training elements is known as “the support vectors” (indicated in FIG. 2 by shading).

The optimal hyperplane parameters are represented as linear combinations of the mapped support vectors in the high dimensional space. Thus, a physical problem (e.g., separating “face” images from “not-face” images, can be solved by reinterpretation, wherein a potentially non-linear decision surface in the context of the original problem is reduced (subject to the limitations described below) to finding a hyperplane boundary in a higher dimensional space. The SVM algorithm is intended to ensure that errors on a set of vectors are minimized by assigning weights to all of the support vectors. These weights are used in computing the decision surface in terms of the support vectors. The algorithm also allows for these weights to adapt in order to minimize the error rate on the training data for a particular problem. These weights are calculated during the training phase of the SVM.

Constructing an optimal hyperplane therefore becomes a constrained quadratic optimization programming problem determined by the elements of the training set and functions determining the dot products in the mapped space. The solution to the optimization problem can be found using conventional optimization techniques.

Subsequently, in the testing phase, the SVM receives elements of a testing set to be classified or otherwise processed. The SVM then transforms the input data vectors of the testing set by mapping them into a multi-dimensional space using support vectors as parameters in the kernel. The mapping function is determined by the choice of the kernel loaded into the SVM. Thus, the mapping involves taking a vector and transforming it into a high-dimensional feature space, so that a linear decision function can be created in that feature space. The SVM can then create a classification signal from the decision surface, indicative of the status (inside/outside the class) of each input data vector. Finally, the SVM can create an output classification signal, such as (as shown in FIG. 2), +1 for a circle and −1 for a box.

Thus, a simple form of classifier SVM defines a plane in n-dimensional space (i.e., a hyperplane) that separates feature vector points associated with objects in a given class from feature vector points associated with objects outside the class. In a multi-class configuration, a number of classes can be defined by defining a number of hyperplanes. In a conventional classification SVM, the hyperplane defined by the SVM maximizes a Euclidean distance from the hyperplane to the closest points (i.e., the support vectors) within the given class and outside the class, respectively.

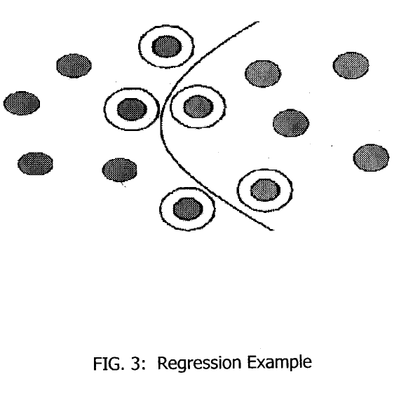

A regression SVM (see, e.g., FIG. 3) determines a best fit curve to selectively fit input data. Regression modeling makes use of splines or Bezier curves as kernel functions. Again, key data points may be identified, and the degree of exactness of fit tailored to appropriate accuracy.

Characteristics of SVMs: SVMs have a number of useful characteristics. For example, the training process amounts to solving a constrained quadratic optimization problem, and the solution thus obtained is the unique global minimum of the objective function. SVMs can be used to implement structural risk minimization, in which the learning machine is controlled so as to minimize generalization error. Also, the support vector decision surface is essentially a linear separating hyperplane in a high dimensional space. Similarly, the SVM can be configured to construct a regression that is linear in some high dimensional space.

SVMs were originally developed for image analysis, to solve the problem of generating a “good example” of a set of images. The SVM methods developed for selection functions were later generalized to cover classification problems, in which representatives of two or more classes are separated by a decision boundary, and regression problems, in which a best-fit curve is generated from example points. In each case, the SVM algorithm requires that a particular objective function be maximized over a collection of variables. The number of variables is the same as the original number of training data examples, and they may be loosely regarded as weighting factors for each of a number of input rows. The objective function is obtained by minimizing a statistical measure called structural risk, thereby optimizing the SVM's ability to process as yet unseen test data. Although the function to be maximized is quadratic in its variables, and thus in principle is relatively simple to solve, there are numerous constraints that must also be satisfied. Consequently, a closed solution cannot be found and numerical methods are necessary. At the maximum point, most of the variables are zero, so that the training examples associated with these variables do not contribute at all to the solution The training examples for which the associated variable is non-zero are called support vectors because they support the entire solution. The support vectors are those close to the decision boundary, and thus most important in generating the regression curve. Other points, which are either further from the boundary or near-duplicates of important ones, are not involved in the solution.

In addition to providing a decision boundary or regression curve, the support vector algorithm provides other information. Crucial data examples are highlighted, thus allowing a high degree of data compression. Depending on the original number of training rows and the length of time for which the algorithm is allowed to run, the required number of examples can be reduced to perhaps 5 or 10% of the original number. This can also be used as a tool for steering future data collection, because it can identify areas of the input space where further examples would supply essentially no information.

The intrinsic shape of a decision boundary or regression curve generated by a support vector algorithm can be varied by selection of a specific kernel function. Several families of these may be used, such as polynomials or Gaussian curves for classification, and splines for regression. In general, making different choices of specific kernel functions affects the large-scale properties of the curve on outlying regions of the input space, away from the training examples; but not the small-scale behavior in regions well populated with training data. To some extent, good choices of kernel functions are dependent on some familiarity with the problem at hand; but there are general rules to assist in selection.

A support vector algorithm may be expected to take longer to reach a result than, for example, a multi-layer perceptron (MLP) network if applied to the same problem. However, the decision boundary is mathematically more reliable, and can be more appropriately contoured to the data supplied. The additional information concerning relative importance of training examples is entirely unavailable using many other methods. Perhaps most importantly, when implemented in accordance with the present invention as described below, SVMs can provide useful results even with incomplete data.

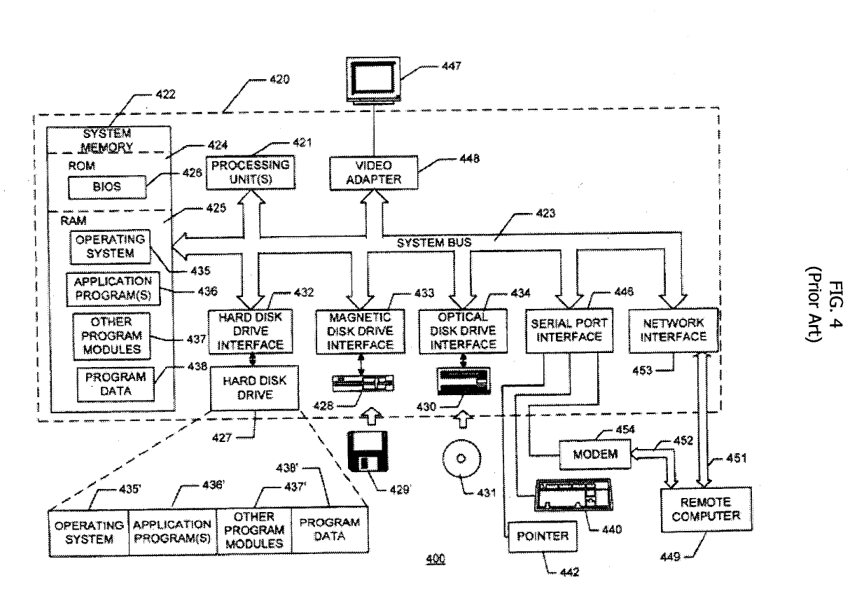

SVMs have been implemented in otherwise relatively conventional computer systems, both standalone and networked, such as the architecture 400 shown in FIG. 4. For example, FIG. 4 depicts a general purpose computing device in the form of a conventional personal computer 420. The personal computer 420 may include a processing unit 421, a system memory 422, and a system bus 423 that couples various system components including the system memory to the processing unit 421. The system bus 423 may be any of several types of bus structures including a memory bus or memory controller, a peripheral bus, and a local bus using any of a variety of bus architectures. The system memory may include read only memory (ROM) 424 and/or random access memory (RAM) 425. A basic input/output system 426 (BIOS), containing basic routines that help to transfer information between elements within the personal computer 420, such as during start-up, may be stored in ROM 424. The personal computer 420 may also include a hard disk drive 427 for reading from and writing to a hard disk, (not shown), a magnetic disk drive 428 for reading from or writing to a (e.g., removable) magnetic disk 429, and an optical disk drive 430 for reading from or writing to a removable (magneto) optical disk 431 such as a compact disk or other (magneto) optical media. The hard disk drive 427, magnetic disk drive 428, and (magneto) optical disk drive 430 may be coupled with the system bus 423 by a hard disk drive interface 432, a magnetic disk drive interface 433, and a (magneto) optical drive interface 434, respectively. The drives and their associated storage media provide nonvolatile storage of machine readable instructions, data structures, program modules and other data for the personal computer 420. Although the exemplary environment described herein employs a hard disk, a removable magnetic disk 429 and a removable (magneto) optical disk 431, those skilled in the art will appreciate that other types of storage media, such as magnetic cassettes, flash memory cards, digital video disks, random access memories (RAMs), read only memories (ROM), and the like, may be used instead of, or in addition to, the storage devices introduced above.

A number of program modules may be stored on the hard disk 423, magnetic disk 429, (magneto) optical disk 431, ROM 424 or RAM 425, such as an operating system 435, one or more application programs 436, other program modules 437, and/or program data 438 for example. A user may enter commands and information into the personal computer 420 through input devices, such as a keyboard 440 and pointing device 442 for example. Other input devices (not shown) such as a microphone, joystick, game pad, satellite dish, scanner, or the like may also be included. These and other input devices are often connected to the processing unit 421 through a serial port interface 446 coupled to the system bus. However, input devices may be connected by other interfaces, such as a parallel port, a game port or a universal serial bus (USB). A monitor 447 or other type of display device may also be connected to the system bus 423 via an interface, such as a video adapter 448 for example. In addition to the monitor 447, the personal computer 420 may include other peripheral output devices (not shown), such as speakers and printers for example.

The personal computer 420 may operate in a networked environment which defines logical connections to one or more remote computers, such as a remote computer 449. The remote computer 449 may be another personal computer, a server, a router, a network PC, a peer device or other common network node, and may include many or all of the elements described above relative to the personal computer 420. The logical connections depicted in FIG. 4A include a local area network (LAN) 451 and a wide area network (WAN) 452, an intranet and the Internet.

When used in a LAN, the personal computer 420 may be connected to the LAN 451 through a network interface adapter (or “NIC”) 453. When used in a WAN, such as the Internet, the personal computer 420 may include a modem 454 or other means for establishing communications over the wide area network 452. The modem 454, which may be internal or external, may be connected to the system bus 423 via the serial port interface 446. In a networked environment, at least some of the program modules depicted relative to the personal computer 420 may be stored in the remote memory storage device. The network connections shown are exemplary and other means of establishing a communications link between the computers may be used.

Although SVMs are known in the prior art (as described in the foregoing discussion), conventional SVMs cannot produce useful results using non-uniform, “partial” or otherwise limited data, because they cannot handle unknowns in various dimensions of the data. As a result, they were heretofore unsuited to provide predictions or other useful results in supply chain or other real-world business settings.

### THE PRESENT INVENTION

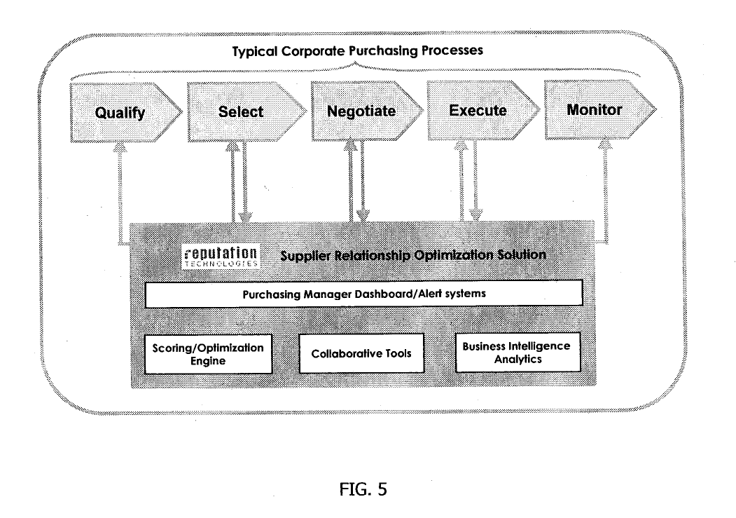

To overcome these problems and provide classification, prediction or other useful results in environments characterized by non-uniform, “partial” or otherwise limited data, the present invention utilizes an augmented version of the SVM-based classification and regression algorithm. For example, methods are described below for selecting data sets for information about a particular supplier, by including all of the supplier's data, as well as utilizing a set of related data from other suppliers. To optimize these processes, a system in accordance with the invention utilizes (a) a method to select appropriate data; (b) a novel modification of prior art SVM algorithms to downplay less-related data; and (c) a processing step performed on the SVM's output that estimates the degree of influence by less-related data on a given decision. To accommodate “partial”, non-uniform, or otherwise limited data, the invention utilizes other variations on the SVM algorithm. When a classification SVM's kernel functions, or a regression SVM's basis functions, are based on linear point-to-point distance, the invention utilizes a “fuzzy” plane-to-plane distance metric; and when the kernel/basis functions are not based on linear distance, the invention utilizes methods to adapt these functions to use partial data. Each of these aspects will next be described in detail in connection with the exemplary system shown in FIG. 5.

The methods described herein can support classification and regression SVMs for use in any of a wide range of applications. While the examples that follow illustrate an application of the invention in an SCM or SRM system, it will be appreciated that the invention can be used to make predictions, or provide classification or other functions in a wide range of applications characterized by non-uniform or otherwise limited data, including weather prediction, Loss Prevention for the retail industry, stock market prediction and the like.

FIG. 5 is a schematic diagram depicting the overall architecture of a Supplier Relationship Management (SRM) system using the SVM techniques of the present invention. (It should be noted that the configuration depicted in FIG. 5 is but one of many ways to utilize the techniques described herein.) The SRM shown is configured for use within a corporate supply chain management (SCM) process. The illustrated SRM can provide analysis and monitoring of supplier performance, using a ratings engine to enable buyers in an organization to compare the attributes of different suppliers, and can analyze and predict supplier performance. In particular, analysis and prediction are provided using SVMs configured as described below, using data about suppliers or vendors, including the outcomes of past transactions, to predict their performance in future transactions. Uses for these predictions can include the following:

1. Assigning a score to each supplier based on their expected performance on a “typical transaction.”

2. Ranking suppliers within a group based on their expected performance on a “typical transaction.”

3. Predicting the performance of a supplier on a planned transaction.

4. Selecting a list of suppliers that we expect to perform best for a planned transaction.

5. Identifying risky transactions by discerning that the transaction differs from ones previously undertaken with a given supplier, or by noticing that transactions similar to the one under consideration have had poor or variable outcomes in the past.

6. Detecting deviations within a supplier's performance by comparing actual to expected performance.

To provide these functions, the SVMs of the present invention can be configured for binary classification, multi-class classification, or regression.

Binary Classification: A classification SVM according to the invention can be used to enable binary predictions useful in answering questions such as: “Is this [proposed transaction] a ‘good’ transaction or a ‘bad’ transaction?” The training vectors x_i are the attribute vectors in the transaction history database and the y_i are the historical classification of those transactions as “good” or “bad.”

Multi-Class Classification: Similarly, multi-class classification SVMs in accord with the invention categorize prospective transactions based on training vectors, but instead of simply providing a binary prediction, predict which of a series of discrete possibilities is most likely. For example, a multi-class classification SVM might choose between the integers 1 . . . 10.

Regression: A regression SVM differs from the classification SVM in that it allows the outcomes y_i to be in R. The machine then attempts to make estimates of the y_i. A regression SVM can be used in an SRM to predict qualitative outcomes, to answer questions such as: “What is the predicted quality of goods, on a scale of 1-10, for the prospective transaction?” Based on the fact that the SVM is forced to generalize during training, and assuming that the future transactions are generated from the same process as the training transactions, a low rate of errors for the y_i in the training set provides higher confidence in predictions for the test set.

SVMs are particularly useful for such purposes, in contrast to traditional linear classification and regression models, because SVMs can use non-linear combinations of input attributes. This is significant in a business setting, such as a corporate purchasing environment, because of inherent domain obstacles. For example, substantially every item of data in a corporate purchasing environment is high-cost, in that the only way to actually prove how a transaction will execute is to conduct the transaction—possibly at a cost of millions of dollars. Consider, for example, buying thousands of tons of steel from a new vendor in order to establish that the vendor is a “good” supplier of steel in such quantities. Given the possible costs, corporations cannot be expected to perform a statistically significant number of “test” transactions simply to find out how well they execute.

Second, because corporations learn most about the suppliers from whom they actually buy, and buy from those suppliers whom they expect to perform best, the resulting sample distribution will be highly non-uniform. The corporation will have far more data about some suppliers than others. But because of the significant potential cost, the corporation cannot necessarily collect more data to render the data more uniform across the universe of suppliers.

Third, corporate data collection techniques are likely to change over time. For example, a food corporation might measure “quality” for a time, but later divide “quality” into two measured dimensions: “quality” and “freshness.” In that case, the earlier data must be regarded as missing values along the “freshness” dimension. This precludes the application of prior art SVMs, since conventional SVM methods do not handle data containing unknowns.

### METHOD ASPECTS OF THE INVENTION

Method of Selecting and Broadening Sample Data: When selecting a data set, the invention utilizes the desired VC (Vapnik-Chervonenkis) dimension to choose the number N of data points required for the SVM. The process begins with adding all transaction data from the supplier or suppliers in question. This is referred to herein as the “base” data set. Next, data are added for other suppliers in the same sector, starting with those for whom we have a low amount of data. Next, we add randomly-selected transactions from high-data suppliers in the same sector. If all data from the sector is exhausted, additional data are added from more general sectors following the same pattern.

Method to Downplay Less-Related Data: For classification SVMs, instead of minimizing the value of {the magnitude of the weight-vector plus the magnitude of the slack vector}, we minimize the following:

{the magnitude of a scaled weight-vector whose components are multiplied by the “significance” of their source}plus {the magnitude of a scaled slack vector whose components are multiplied by the “significance” of their source}.

In this example, the “significance” of a data point is set to 1 if it belongs to the base set; ½ if it belongs to the same sector, and ¼ otherwise. Other values may be used, and the selection of these values is left to the implementer.

For regression SVMs, analogous to the above approach, we weight the components of the parameter vector by their significance in the terms of the maximized quantity.

For iterative classification and regression algorithms, we select a higher learning rate for more “significant” points, as described above in connection with classification SVMs.

Postprocessing step on SVM output to estimate degree of influence by less-related data: For classification, after executing the SVM training algorithm, we note the fraction of significance=1.0 points in the support vector set. This value is referred to as the specificity of the SVM. When performing classification, we note the fraction of the sum-squared-contribution of significance=1.0 points. This fraction is the specificity of the classification.

For regression, after performing the SVM training algorithm, we note the fraction of y_i*alpha_i that results from significance=1.0 points. This value is the specificity of the SVM. When performing regression, we note that the sum-squared-contribution of significance=1.0 points to the result. This fraction is the specificity of the result.

Distance metrics for partial data: As a general matter, in the SVM algorithm, we are less interested in the data (x_i, y_i) themselves than in the feature-space defined by the selected kernel function K(x_i, x_j). Because of this, we can configure the SVM to handle partial data by defining a kernel function that allows partial data. Some kernel functions depend only on the linear distance of the points x_i, x_j; and we consider these first.

Distance-Dependent Kernel Functions: It will be appreciated that instead of a point in n-space, each partial datum actually determines a plane. However, this is less useful than it might first appear, since most pairs of planes will intersect, and even when certain pairs of planes are parallel, the plane-to-plane distance will give the minimal distance between partial data, hence exaggerating the importance of such partial data and distorting the results. One practice of the invention avoids this problem by utilizing one of several ersatz distance metrics in place of Euclidean distance when computing the distance between partial data. Implementation and testing have demonstrated that a highly useful metric is derived by assuming that when one or both data have a missing element in a given dimension, they differ in that dimension by 2*sigma (where sigma=one standard deviation), or 1.0, or the distance of the known dimension to the boundary, whichever is less. In other words, the distance between two data is given by the following expression:

$$SQRT ( {{SUM}^{n\_dim}}_{i = 0} ( dist ( x\_i , y\_i ) \hat{} 2 ) )$$

where dist(a,b)=(a−b) if a and b are known,

and dist(a,b)=min(d_avg, max(a,1.0−a)) if a is known but b is not.

and dist(a,b)=min(d_avg, 1.0) if neither a nor b is known

for d_avg =2*sigma.

Non-distance-dependent kernel functions: Again, optimal results are attained by avoiding a maximal or minimal kernel value, and instead utilizing an average-case solution. In accordance with the invention, the basic approach is as follows: when confronted with a pair of partial data, evaluate the kernel function with the unknowns set successively to each observed value along the unknown dimension, then take the mean of the results. However, this approach can be computationally expensive, since generating the matrix of K's will run from O(n_data\hat{ }2) to O(n_data\hat{ }2*n_data\hat{ }max_unknown_dims).

Accordingly, the invention can be practiced by taking a sampling approach: instead of walking the entire set, we sample from the set in order to fill in values for the unknown dimensions. This lowers the time to O(n_data\hat{ }2*sample_size\hat{ }max_unknown_dims).

Another method that can be used is to integrate to find a closed-form formula for each possible number of partial dimensions. It can also be useful to first take a Taylor expansion (or other simplification) of the kernel function. Kernel function simplifications are known in the art, and these variations are left to the implementer.

Degree of Confidence: The invention can also provide degree of confidence values for classifications and predictions. As a general matter, a classification SVM simply indicates which side of a dividing line (or curve) a given new point is on. In order for the prediction to be useful, it is desirable to provide a confidence estimate along with the classification, to answer questions such as: “How certain are we that this classification is correct?” In accordance with the invention, one useful way of providing such an estimate is to run a single-class classification machine on the entire data set (including both positive and negative training samples). In this case, rather than determining if a test point is “like the positives” or “like the negatives”, the SVM instead determines if a test point is “like the data ” or “not like the data”. The single-class classification SVM attempts to bind the training data with a hypersphere, with a radius that is tunable, based on how close a fit is desired. A new point can then be classified based on distance from the center of the hypersphere. When combined with the above-described kernel functions having a distance measurement that handles unknown data, the invention can provide confidence estimates even when only partial data are available.

### EXAMPLE OF METHOD STEPS AND RESULTS GENERATED

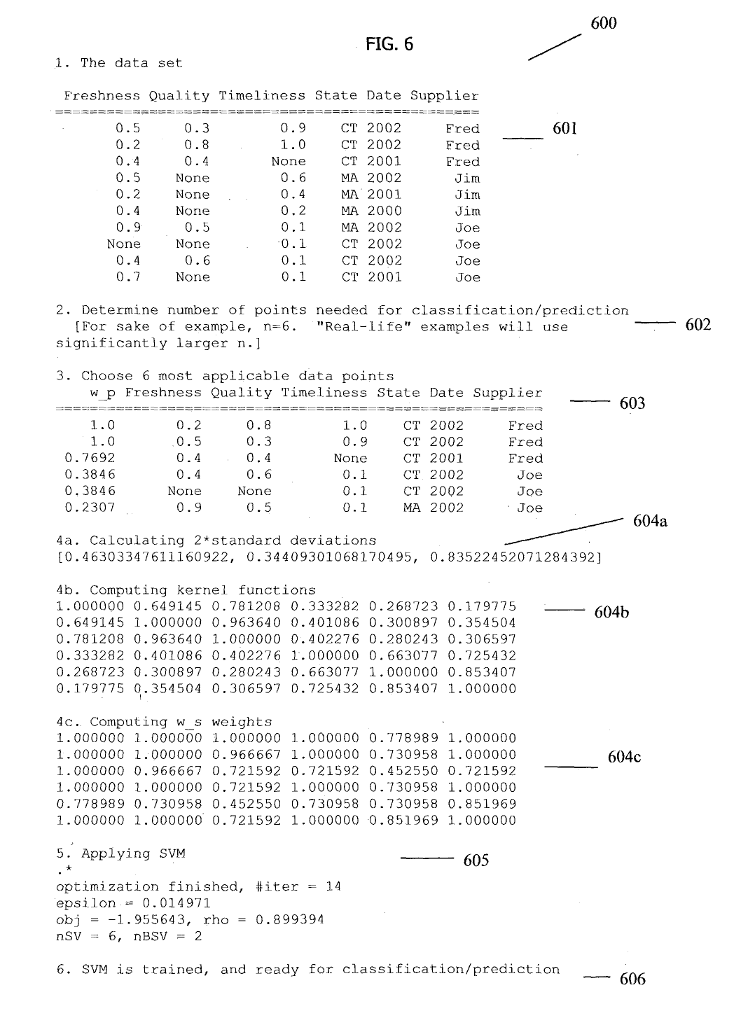

FIG. 6 is a flowchart illustrating an SVM method according to the invention. As shown in FIG. 6, the method 600 can include steps 601-606, as follows:

601. Receive data set. In a supply chain (SCM) or similar system, the data can include values such as freshness, quality, purity, timeliness, price and the like. In other systems (for weather forecasting, financial analysis or the like) other suitable data can be used.

602. Determine number of points needed for classification/prediction.

603. Choose 6 most applicable data points. In the illustrated example, 6 points are returned. Real-world problems are likely to use far more points.

604a. Calculate 2 standard deviations, the metric described above.

604b. Compute kernel functions. Here, the kernel function is evaluated at every pair (a pair-wise calculation).

604c. Compute w_s weights. Values of w_s (relevance weighting coefficients) can be selected by the implementer to tune the system for optimal results. This step is optionally used to further downweight partial data, which may be useful where the value of coefficient K is not well-tuned.

605. Apply SVM. In the example shown, a freeware SVM computational package is used.

606. SVM is trained, and ready for classification/prediction.

### CONCLUSION

The SVM implementations described herein overcome several problems that would otherwise preclude application of SVMs to corporate purchasing, supply chain management, Loss Prevention for the retail industry or other real-world applications. In particular, SVMs were not heretofore capable of accommodating data sets containing unknowns, or in which some data are missing measurements along some of their dimensions (e.g., freshness or quality values), or in which different amounts of data are available on different subjects (e.g., more data available for suppliers whom we've actually used in the past, than for other suppliers). As noted above, these characteristics are typical of corporate purchasing and other real-world environments in which, for example, data collection techniques are likely to change over time (e.g., first measuring “quality” and then dividing “quality” into two dimensions of “freshness” and “quality”, resulting in data having high disparity and low overlap.

In contrast, the augmented versions of the SVM classification and regression algorithm used in the invention can: (1) deliver predictions for all suppliers for which we have data, regardless of how much data we have for each (when we have little data about a supplier, we can inform the user that our predictions are based partially on general supplier behavior patterns, rather than on the particular supplier's past behavior); and (2) incorporate non-uniform data (e.g., transaction outcomes with differing measurement sets) without discarding data points. Prior art SVM techniques cannot provide these benefits.

The invention thus provides novel SVM techniques and implementations that can yield useful results even from non-uniform, “partial” or otherwise limited data typical of business enterprises and other real-world settings. The invention thus eliminates deficiencies that have limited the usefulness of prior art analytic tools.

While the examples described above relate generally to supply chain and supplier performance management (i.e., SCM and SRM systems), it will be appreciated that the techniques and systems described herein are readily applicable to other business or information management applications

Having described the illustrated embodiments of the present invention, it will be apparent that modifications can be made without departing from the spirit and scope of the invention, as defined by the appended claims.

We claim:

1. In a system for providing information about events, a method of predicting an event attribute, the method comprising:
receiving a data set indicative of prior event attributes, at least one datum of the data set being incomplete in at least a first dimension;
configuring a support vector machine to process the data set to predict the event attribute, the configuring including defining a kernel function operable on incomplete data.

2. The method of claim 1 wherein the event attribute predicted is an event outcome.

3. The method of claim 1 wherein defining a kernel function includes defining a distance metric operable on partial data.

4. The method as in any of claims 1-3 wherein the method further comprises:
selecting a data set indicative of a plurality of prior event attributes;
manipulating the data set to create a modified data set substantially having statistical significance;
calculating a pair-wise similarity for the modified data set by treating an unknown data value of the modified data set as a function of the pair-wise similarity calculation; and
predicting the event attribute as a function of the pair-wise similarity.

5. The method of claim 4 wherein the event is a transaction.

6. In a system for providing information about events, a method of classifying events, the method comprising:
receiving a data set indicative of prior event attributes, at least one datum of the data set being incomplete in at least a first dimension; and
configuring a support vector machine to process the data set to classify the events, the configuring including defining a kernel function operable on incomplete data.

7. The method of claim 6 further comprising classifying any of prior or future events.

8. The method of claim 6 wherein event attributes include risk parameters.

9. The method of claim 6 Wherein defining a kernel function includes defining a distance metric operable on partial data.

10. The method of claim 6 further comprising providing a binary classification.

11. The method of claim 6 further comprising providing a multi-class classification.

12. The method as in any of claims 6-11 wherein the method further comprises:
selecting a data set indicative of a plurality of prior event attributes;
manipulating the data set to create a modified data set substantially having statistical significance;
calculating a pair-wise similarity for the modified data set by treating an unknown data value of the modified data set as a function of the pair-wise similarity calculation; and
classifying as a function of the pair-wise similarity.

13. The method as in any of claims 1-5 further comprising configuring the SVM to be operable to provide regression using incomplete data, thereby to predict qualitative event attributes.

14. A method of making a prediction of a vendor attribute, comprising the steps of:
selecting a data set indicative of a plurality of vendor attributes, the data set having a plurality of unknown data values;
manipulating the data set to create a modified data set substantially having statistical significance;
calculating pair-wise similarity for said modified data set by treating an unknown data value of the modified data set as a function of the pair-wise point-to-point similarity calculation; and
making the prediction of the vendor attribute in response to the pair-wise similarity.

15. The method of claim 14 wherein the vendor attribute comprises a transaction outcome.

16. A method of predicting an attribute of a physical phenomenon based on an incomplete data set, comprising the steps of:
selecting a data set indicative of a plurality of attributes of the physical phenomenon, the data set having a plurality of unknown data values;
manipulating the data set to create a modified data set substantially having statistical significance;
calculating pair-wise similarity for the modified data set by treating an unknown data value of the modified data set as a function of the pair-wise similarity calculation; and
making the prediction of the attribute of a physical phenomenon in response to the pair-wise similarity.

17. A method of making a prediction based on an incomplete data set, the method comprising:
selecting a data set having a plurality of unknown data values;
manipulating the data set to create a modified data set substantially having a number of data points sufficient to satisfy a selected statistical significance threshold;
calculating pair-wise similarity for the modified data set by treating an unknown data value as a function of the pair-wise similarity calculation; and
making the prediction in response to the pair-wise similarity.

18. The method of claim 17 wherein the manipulating comprises starting with a first core data set and expanding the first core data set to create the modified data set.

19. The method of claim 17 wherein the manipulating comprises starting with a first core data set and contracting the data set to create the modified data set.

20. The method of claim 17 wherein statistical significance is determined by a VC dimension.

21. The method of claim 17 further comprising calculating a first weighting factor.

22. The method of claim 21 wherein the first weighting factor is Ws.

23. The method of claim 21 wherein the calculating of the first weighting factor comprises making a distance measurement.

24. The method of claim 23 wherein the distance measurement is a function of a statistical standard deviation of a set of data values.

25. The method of claim 17 wherein the calculating of a pair-wise similarity comprises selecting a tunable kernel function.

26. The method of claim 25 wherein the kernel function includes a distance measurement.

27. The method of claim 26 wherein the distance measurement is a function of a statistical standard deviation of a set of data values.

28. The method of claim 17 further comprising calculating a second weighting factor.

29. The method of claim 28 wherein the second weighting factor is Wp.

30. The method of claim 17 wherein making the prediction is performed by a support vector machine.

31. An apparatus for predicting an event attribute comprising:
means for receiving a data set indicative of prior event attributes, at least one datum of the data set being incomplete in at least a first dimension; and
means for configuring a support vector machine to process the data set to predict the event attribute, the configuring including defining a kernel function operable on incomplete data.

32. The apparatus of claim 31 wherein the apparatus further comprises:
means for selecting a data set indicative of a plurality of prior event attributes;
means for manipulating the data set to create a modified data set substantially having statistical significance;
means for calculating a pair-wise similarity for the modified data set by treating an unknown data value of the modified data set as a function of the pair-wise similarity calculation; and
means for predicting the event attribute as a function of the pair-wise similarity.

33. An apparatus for classifying events comprising:
means for receiving a data set indicative of prior event attributes, at least one datum of the data set being incomplete in at least a first dimension; and
means for configuring a support vector machine to process the data set to classify the events, the configuring including defining a kernel function operable on incomplete data.

34. The apparatus of claim 33 wherein the apparatus further comprises:
means for selecting a data set indicative of a plurality of prior event attributes;
means for manipulating the data set to create a modified data set substantially having statistical significance;
means for calculating a pair-wise similarity for the modified data set by treating an unknown data value of the modified data set as a function of the pair-wise similarity calculation; and
means for classifying as a function of the pair-wise similarity.

35. An apparatus for making a prediction of a vendor attribute comprising:
means for selecting a data set indicative of a plurality of vendor attributes, the data set having a plurality of unknown data values;
means for manipulating the data set to create a modified data set substantially having statistical significance;
means for calculating pair-wise similarity for said modified data set by treating an unknown data value of the modified data set as a function of the pair-wise point-to-point similarity calculation; and
means for making the prediction of the vendor attribute in response to the pair-wise similarity.

36. An apparatus for predicting an attribute of a physical phenomenon based on an incomplete data set, comprising:
means for selecting a data set indicative of a plurality of attributes of the physical phenomenon, the data set having a plurality of unknown data values;
means for manipulating the data set to create a modified data set substantially having statistical significance;
means for calculating pair-wise similarity for the modified data set by treating an unknown data value of the modified data set as a function of the pair-wise similarity calculation; and
means for making the prediction of the attribute of a physical phenomenon in response to the pair-wise similarity.

37. An apparatus for making a prediction based on an incomplete data set comprising:
means for selecting a data set having a plurality of unknown data values;
means for manipulating the data set to create a modified data set substantially having a number of data points sufficient to satisfy a selected statistical significance threshold;
means for calculating pair-wise similarity for the modified data set by treating an unknown data value as a function of the pair-wise similarity calculation; and
means for making the prediction in response to the pair-wise similarity.
